(19) United States
(12) Patent Application Publication
(10) Pub. No.: US 2007/0104252 A1
(43) Pub. Date: May 10, 2007

(54) METHOD AND APPARATUS FOR ESTIMATING FREQUENCY OFFSET IN A WIRELESS MOBILE COMMUNICATION SYSTEM

(75) Inventor: June Jang, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/558,327

(22) Filed: Nov. 9, 2006

(30) Foreign Application Priority Data
Nov. 9, 2005 (KR) 10-2005-107035

(51) Int. Cl. H04B 1/00

(52) U.S. Cl. 375/147

(57) ABSTRACT

A method of estimating frequency offset in a code division multiple access (CDMA) wireless communication system is disclosed. More specifically, the method includes receiving a training sequence, wherein the training sequence is represented by a plurality of periodically repeated training symbols, acquiring each of a plurality of phase difference values using the received training symbols, wherein each phase difference value is obtained by comparing two training symbols which are received in a specified time distance, and obtaining the frequency offset using the acquired each of the plurality of the phase difference values

This application claims the benefit of Korean Application No. P10-2005-107035, filed on Nov. 9, 2005, which is hereby incorporated by reference.

### BACKGROUND OF THE INVENTION

1. Field of the Invention

The present invention relates to estimating frequency offset, and more particularly, to a method and apparatus for estimating frequency offset in a wireless mobile communication system.

2. Discussion of the Related Art

A frequency offset can be defined by a frequency difference caused by in a part of the oscillator of a mobile station (MS) and a Doppler effect of channel(s). Frequency synchronization is then used to estimate the frequency offset and continuously compensate for the frequency offset using the estimated frequency offset. However, the frequency offset causes sampling error at a receiving end, and the frequency offset is accumulated causing deterioration of receiving capability.

A conventional code division multiple access (CDMA) system using frequency division duplex (FDD) mode uses sequential common pilot channels (CPICH). On the contrary, a time division multiple (TDD) mode uses non-sequential pilot channels to compensate for the frequency offset phenomenon since the TDD mode does not support sequential pilot channels. That is, the non-sequential pilot channels are used to estimate frequency offset and achieve accurate frequency synchronization.

An automatic frequency control (AFC) is used to reduce the reception deterioration effect caused by the frequency difference between the transmitting end and the receiving end. According to the conventional method, the frequency offset is estimated using an estimated phase difference (also referred to as “estimated theta”) acquired through a complex multiplier between a midamble code and a received channel noise. Here, the midamble code is used as a reference with respect to a midamble code which is processed through the frequency offset.

The conventional frequency offset estimation method has following problems. First, an accurate starting point of downlink synchronization (SYNC-DL) code and a midamble code are necessary to multiply with the reference code. The product of the multiplied codes can be used to apply a least square method. Consequently, generating frame array and the reference code can become complicated. Second, therefore, if the starting point is inaccurately determined, then the conventional frequency offset estimation method may become less reliable. Third, since the phase difference due to the frequency offset between chips is very small, there is a limit to a number of bits that can be used in practice. Consequently, performance can suffer causing complexity due to a small resolution that can be expressed with respect to the phase value.

### SUMMARY OF THE INVENTION

Accordingly, the present invention is directed to a method and apparatus for estimating frequency offset in a wireless mobile communication system that substantially obviates one or more problems due to limitations and disadvantages of the related art.

An object of the present invention is to provide a method of estimating frequency offset in a code division multiple access (CDMA) wireless communication system.

Another object of the present invention is to provide a method of estimating frequency offset in a wireless communication system.

In a further object of the present invention is to provide an apparatus for estimating frequency offset in a code division multiple access (CDMA) wireless communication system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of estimating frequency offset in a code division multiple access (CDMA) wireless communication system includes receiving a training sequence, wherein the training sequence is represented by a plurality of periodically repeated training symbols, acquiring each of a plurality of phase difference values using the received training symbols, wherein each phase difference value is obtained by comparing two training symbols which are received in a specified time distance, and obtaining the frequency offset using the acquired each of the plurality of the phase difference values

In another aspect of the present invention, a method of estimating frequency offset in a wireless communication system includes receiving a training sequence, wherein the training sequence is represented by a plurality of periodically repeated training symbols, acquiring a phase difference value between a first training symbol and a second training symbol, wherein the first training symbol and the second training symbol are received at different time instances, and determining the frequency offset using the acquired phase difference value.

In a further aspect of the present invention, an apparatus for estimating frequency offset in a code division multiple access (CDMA) wireless communication system includes a phase detection module for receiving a training sequence, and acquiring each of a plurality of phase difference values using the received training sequence, wherein the training sequence is represented by a plurality of periodically repeated training symbols and wherein each phase difference value is obtained by comparing two training symbols which are received in a specified time distance, a combining module for combining at least one phase difference detected by the phase detection module, and a frequency offset output module for calculating the frequency offset using the acquired each of the plurality of the phase difference values.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a block diagram illustrating frequency offset estimation;

FIG. 2 illustrates a downlink sub-frame format of a 3^{rd} Generation Partnership Program (3GPP) TDD Low Chip Rate (LCR) system;

FIG. 3 is a block diagram illustrating frequency offset estimation according to an embodiment of the present invention;

FIG. 4 illustrates a method of selecting D chip;

FIG. 5 illustrates a phase diagram according to an embodiment of the present invention; and

FIG. 6 illustrates a performance graph of the AFC between a least squared (LS) scheme and an embodiment of the present invention.

### DETAILED DESCRIPTION OF TH INVENTION

Reference will now be made in detail to the preferred embodiments of the present invention, examples of which are illustrated in the accompanying drawings. Wherever possible, the same reference numbers will be used throughout the drawings to refer to the same or like parts.

In receiving signals transmitting from the transmitting end, if there is no signal distortion (e.g., fading noise) or damage to the signal, the phase of a midamble code received by the receiving end (e.g., MS) has a slope proportional to a frequency offset. The phase of the midamble code can be expressed in linear form according to Equation 1.
θ(n)=2πf₀nT+θ₀ [Equation 1]

Here, θ₀ represents a specified phase offset at a burst starting point, and f₀ represents the frequency offset.

With reference to the linear form, a least square (LS) technique can be applied to estimate the frequency offset. The calculation of the LS according to the LS technique refers to determining the phase difference using a sum-of-product between the sequential samples of the phase signal and pre-calculated estimation number.

FIG. 1 is a block diagram illustrating frequency offset estimation. The discussion of FIG. 1 will be made in terms of stages (or process). In stage 1, a reference code is searched, and a synchronization downlink (SYNC-DL) code and a midamble code are generated so that the reference code information can be used for the received signal.

Stage 2 refers to phase unwrapping. That is, in the phase unwrapping stage, the calculation is performed with the phase set at 2π. Hence, if 0 is fixed as the mid-point, non-continuous points appear at −π and π. Because of such an occurrence, the phase has to be unwrapped to offset or cancel this type of occurrence in linear estimation while having the calculated samples exist on a straight line. More specifically, if |θ_{ω}(n)−θ_{ω}(n−1) exceeds π and the estimated theta is a negative value, a value of 2π is added. On the contrary, if |θ_{w}(n)−θ_{w}(n−1) exceeds π and the estimated theta is of a positive value, a value of 2π if is subtracted,

Stage 3 refers to frequency offset estimation. A phase signal corresponding to a fixed frequency is expressed as |θ(n)=ω₀nT+θ₀+η(n)| which is a lamp function with noise mixed therein and the phase error, η(n), caused by fading and noise is added thereto. Further, a liner regression can be used to obtain a linear line \hat{θ}(n)=\hat{ω}nT+\hat{θ} which is close to θ(n) with respective to minimizing a sum of error [θ(n)−\hat{θ}(n)]². The minimum estimated value \hat{ω} and \hat{θ} of values ω₀ and θ₀ minimizes sum-squared error to obtain a number of chips for each SYNC-DL and/or midamble, as shown in Equation 2.

$$ɛ = {\sum }_{n = 1}^{N} {[ θ ( n ) - ( \hat{ω} nT + \hat{θ} ) ]}^{2} \qquad [ Equation 2 ]$$

Here, θ(1) is considered as a first phase sample, and N denotes a number of samples of θ(n) used for estimation. Further, a minimum value ε can be calculated by setting ∂ε/∂\hat{ω} and ∂ε/∂\hat{θ} as 0 and using two linear equations to determine the values of value \hat{ω} and \hat{θ}.

The frequency offset can be expressed according to Equation 3.

$$\hat{ω} = A {\sum }_{n = 1}^{N} n θ ( n ) + B {\sum }_{n = 1}^{N} θ ( n ) = {\sum }_{n = 1}^{N} ( An + B ) θ ( n ) \\ A = \frac{1}{T} \frac{N}{N {\sum }_{n = 1}^{N} {n}^{2} - {( {\sum }_{n = 1}^{N} n )}^{2}} = \frac{12}{T ( N - 1 ) N ( N + 1 )} \\ B = \frac{1}{T} \frac{{\sum }_{n = 1}^{N} n}{N {\sum }_{n = 1}^{N} {n}^{2} - {( {\sum }_{n = 1}^{N} n )}^{2}} = \frac{6}{T ( N - 1 ) N} \qquad [ Equation 3 ]$$

The expression of the frequency offset \hat{ω} relates to a sum-of-product, such as a fixed value cₙ=An+B having a sequential phase sample θ(n).

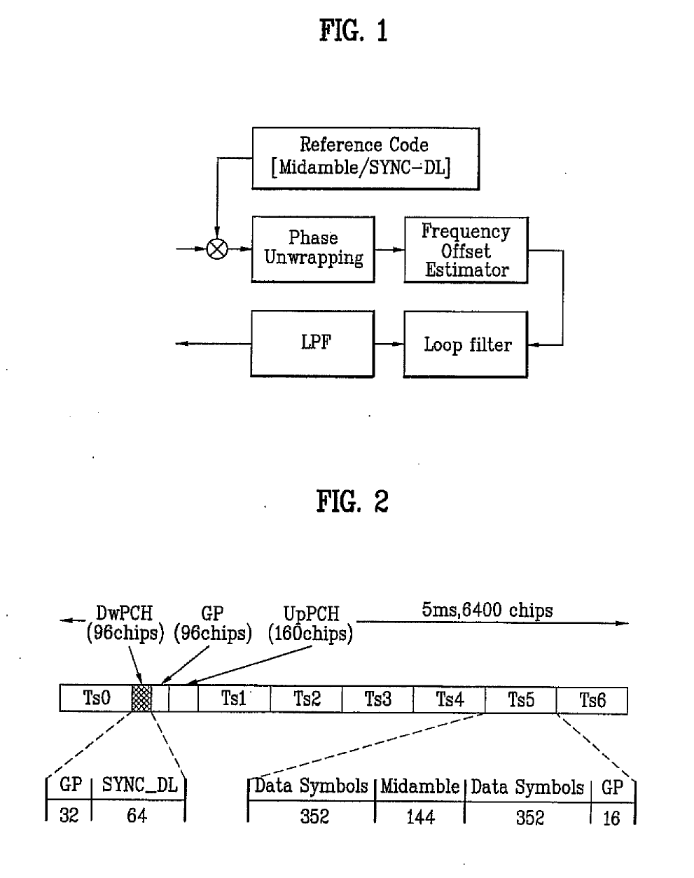

FIG. 2 illustrates a downlink sub-frame format of a 3^{rd} Generation Partnership Program (3GPP) TDD Low Chip Rate (LCR) system. Referring to FIG. 2, there are 32 types of downlink synchronization (SYNC-DL) codes, and each code has a duration or length of 64 chips. The SYNC-DL code appears after a first downlink time slot (Ts0) of the sub-frame. Further, DwPTS comprises a guard period having a 32-chip length and the SYNC-DL code having 64-chip length. Here, one out of 32 SYNC-DL codes is used per each cell.

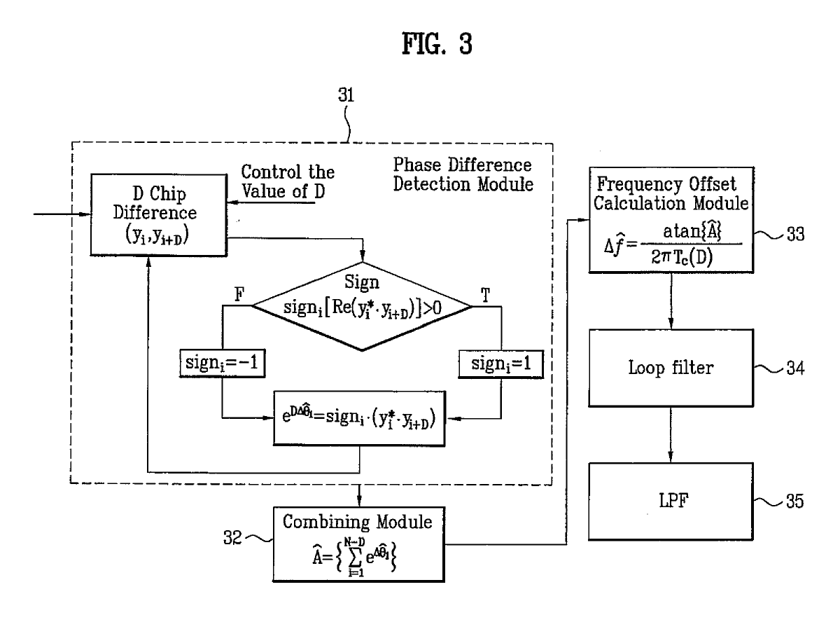

FIG. 3 is a block diagram illustrating frequency offset estimation according to an embodiment of the present invention. The frequency offset estimation is carried out at the receiving end (e.g., MS). As such, the frequency offset estimation can be carried out using internal functions or external functions of the receiving end.

Referring the frequency offset estimation of FIG. 3, the receiving end includes a phase detection module 31 for estimating the phase difference between two (2) signals, in which the difference can be represented in D chips. The value of D can be used to represent the distance between two (2) training symbols with respective to time in detecting/estimating phase difference. Here, the value of D chips can vary. Moreover, the receiving end includes a combining module 32 for combining phase difference of a pair of training symbols (or training sequence) detected by the phase detection module 31. The receiving end further includes a frequency offset output module 33 for outputting the frequency offset determined at the combining module 32.

More specifically, the phase detection module 31 detects two (2) signals out of a plurality of signals received from the transmitting end (e.g., a base station or a network). Here, the difference can be measured in units of chip(s). That is, the chips or D chips represent distance in terms of time.

The two (2) detected signals have a phase difference of D chips or distance of a specified number of chips with respective to time. As discussed, the value of D chips can vary depending on the measured signals. To determine the phase difference or to determine the value of D, the characteristics of the training sequence, such as the SYNC-DL code and the midamble code, can be used.

The two signals selected or used to detect the phase difference are preferably signals from the SYNC-DL code or the midamble code of the received downlink sub-frame. Further, the conventional or well-known methods can be used for detecting the SYNC-DL code or the midamble code of the downlink sub-frame.

The SYNC-DL code is comprised of 32 code groups and 64 chips. Each reference SYNC-DL code, s=(s₁, s₂, . . . , s₆₄), can be mapped as shown in 3GPP Technical Standards TS 25.223 Table AA1.

The transmitting end (e.g., a base station) uses the reference SYNC-DL code to generate a complex SYNC-DL code for downlink transmission. A method associated with generating the complex reference SYNC-DL code by using the reference SYNC-DL code is shown in Equation 4.
sᵢ(j)ⁱ·sᵢ sᵢε{1,−1}, i=1, . . . , 64 [Equation 4]

Here, s denotes the complex SYNC-DL code. Further, sᵢ corresponding to the complex SYNC-DL code s includes a real value and an imaginary value, whose values are repeated, based on i.

The midamble code can be generated by using the reference midamble code. There are a total of 128 reference midamble codes. The same midamble code is used in each cell. Further, the midamble code can be generated by changing the phase of any one of 128 reference midamble codes. The generated midamble code can take various or different forms by applying cyclical time-shift method. In other words, by cyclically time-shifting the generated midambles, different types of sets of midambles can be generated. As such, depending on the time slots, the midamble code can be expanded up to 16 types of midamble combinations.

Further, the reference midamble can be expressed by mₚ=(m₁, m₂, . . . , mₚ). Each of the reference midamble can be mapped as shown in 3GPP Technical Standards TS 25.223 Table AA1.

If a quadrature phase shifting keying (QPSK) scheme is used to change or modify the training sequence into a complex format, the training sequence can be changed to a complex reference midamble form as shown in Equation 5.
mₚ=(m₁, m₂, . . . , mₚ) [Equation 5]

Here, mᵢ=(j)ⁱ·mᵢ for all i=1, . . . ,P and W=[P/K]. The complex reference midamble can be expressed in various types/forms whose size corresponds to iₘₐₓ=Lₘ+(K−1)W . This periodic reference mid amble is used, and a midamble, mᵢ^{(k)}=(m₁, m₂, . . . ,m_{L}_{ₘ}^{(k)}), having Lₘ length for k^{th} user can be expressed according to Equation 6.
mᵢ^{(k)}=m_{i+(K-k)W},i=1, . . . ,Lₘ,k=I, . . . , K [Equation 6]

Here, the i^{th} training symbol can be referred to as yᵢ, and the i+D^{th} training symbol can be referred to as y_{i+D}. Due to the characteristics associated with generating the training sequence, the training symbols generated by multiples of two (2) can become a training symbol having a form of a complex number, each of which alternately appear on first/fourth quadrant or second/third quadrant. Alternatively, the training symbols can appear alternately on first/third quadrant or second/fourth quadrant. In short, each training symbol appear alternately having the phase difference of 180 degrees. In addition, if the signs (e.g., positive or negative) corresponding to the training symbols are not considered, then the two (2) symbols can be expressed or appear on the same quadrant (e.g., phase axis),

The i^{th} training symbol, yᵢ, and the i+D^{th} training symbol, y_{i+D}, can be defined according to Equation 7.
yᵢ=aᵢe^{jθ}^{₀},y_{i+D}=a_{i+D}e^{j(θ}^{₀}^{DΔθ)} [Equation 7]

Here, D denotes 2n where n is a positive number between 0<n<N/2. Moreover, N represents a total length of the training symbol, such as the SYNC-DL code or the midamble code.

Referring the Equation 7, aᵢdenotes a training sequence where i=1, . . . , N; a*ᵢaᵢ=1. More specifically, the total length of SYNC-DL code is 64, and the total length of the midamble code is 128. In addition, yᵢ denotes an input data corresponding to a total of N number of samples for frequency offset estimation. Further, Δθ denotes the phase difference between chips based on frequency offset, and θ₀denotes an initial phase value of the training sequence (or symbol).

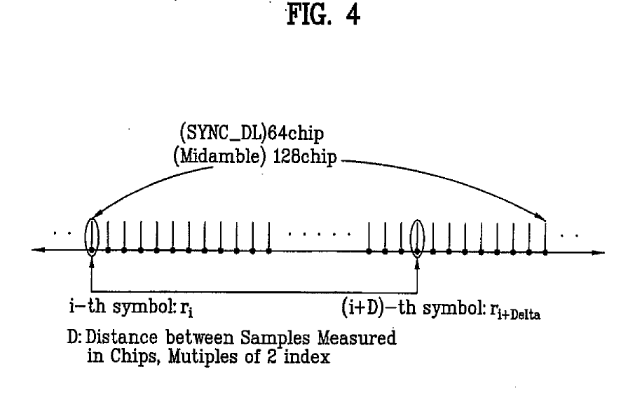

According to the conventional method of estimation, the phase difference is estimated between the received signal and the reference signal by using the inner product of the received signal. However, in a time division-synchronous division multiple access (TD-SCDMA) system, two (2) training symbols are always located in the same phase axis, and these two (2) training symbols are separated by a distance equaling multiples of two (2). By using this characteristic, the phase difference between symbols can be obtained without having to generate the training symbols. In short, since the phase difference distance, D, can vary, preferably, D is the distance between two (2) training symbols represented on the same phase axis. FIG. 4 illustrates a method of selecting D chip.

Since the estimated phase difference value caused by frequency offset can be acquired using a tan( ) function, the range of the value for phase estimation is

$$- \frac{π}{2} ∼ \frac{π}{2} .$$

y*ᵢ·y_{i+D}=a*ᵢa_{i+D}e^{j(DΔθ)}=e^{j(DΔθ±π)} [Equation 8]

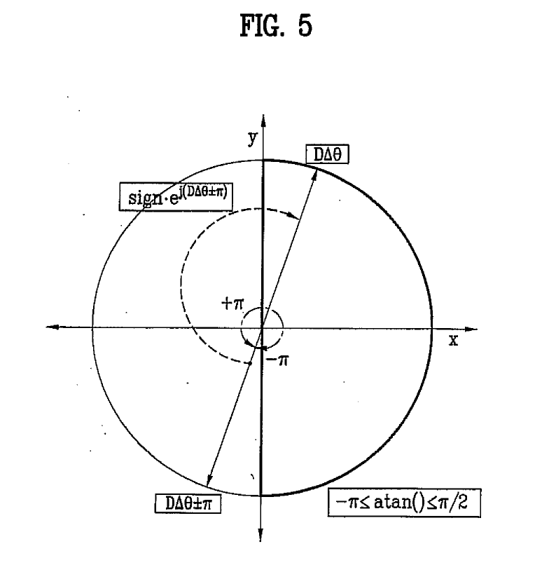

Here, since a*ᵢa_{i+D} has a value of either 1 or −1, the effect caused by this can be negated. As such, in order to obtain the phase value of the desired e^{j(DΔθ)}, the method as illustrated in FIG. 5 can be applied.

FIG. 5 illustrates a phase diagram according to an embodiment of the present invention. That is, y*ᵢ·y_{i+D} between the received symbols is used to determine whether the sign of Re{a*ᵢa_{i+D}e^{j(DΔθ)} of a*}ᵢa_{i+D}e^{j(DΔθ)} is positive or negative. If the sign is negative, the sign value according to Equation 10 can be used in order to make it symmetrical to a point of origin or a reference point.

$$\begin{matrix}sign \cdot {ⅇ}^{j ( D Δ θ \pm π )} = {ⅇ}^{j ( D Δθ )} & [ Equation 9 ] \\ sign = \{ \begin{matrix}1 & if Re \{ ( {a}_{i}^{*} {a}_{i + D} {ⅇ}^{j ( D Δθ )} \} > 0 \\ - 1 & else\end{matrix} & [ Equation 10 ]\end{matrix}$$

Further, the effect corresponding to undesired element can be excluded or eliminated, and the phase difference can be obtained from the training symbols received in D chip intervals.

Referring to FIG. 3, a length of the training sequence can be represented by N. In other words, the value of N represents the length of all of the training symbols received. Again, the value of D represents the distance, with respective to time, between the received training symbols.

The combining module 32 combines the phase differences of a plurality of training symbols. In detail, the distance in D chips, with respect to time, are measured for two training symbols. Hereafter, the two training symbols whose in-between distance is measured can be referred to as a pair of training symbols. In the combining module 32, the plurality of phase differences corresponding to a plurality of pairs of training symbols are combined. More specifically, there is a total of (N−D) number of pairs of training symbols detected by the phase detection module 31.

Further, the output value of the phase difference for (N−D) number of samples can be accumulated as shown in Equation 11 to achieve diversity gain. Since each chip represents an interval which is usually less than noise, D chips are accumulated so as to represent true difference value.

$$\begin{matrix}{\sum }_{i = 1}^{N - D} {y}_{i}^{*} \cdot {y}_{i + D} = {\sum }_{i = 1}^{N - D} {a}_{i}^{*} {a}_{i + D} {ⅇ}^{j ( D Δθ )} \\ ⇒ {\sum }_{i = 1}^{N - D} ( {sign}_{i} ) \cdot {ⅇ}^{j ( D Δθ \pm π )} \\ = {\sum }_{i = 1}^{N - D} {ⅇ}^{j ( D Δθ )} \end{matrix} \qquad [ Equation 11 ]$$

Referring to Equation 11, a total number of accumulated values become samples in which a distance between chips is subtracted from a total number of chips (N−D). In order to obtain the estimated theta (the phase difference) between the combined symbols, a function, a tan( ), can be used to obtain the subsequent Δ\hat{θ} according to the following equation,

$$Δ \hat{θ} = a tan \{ {\sum }_{i = 1}^{N - D} {y}_{i}^{*} {y}_{i + D} \} \qquad [ Equation 12 ]$$

The frequency offset output module 33 calculates the frequency offset from the output value of the combining module 32. That is, the value of Δ\hat{θ} obtained using Equation 9 can be applied to Equation 13, which defines the relationship between the phase and the frequency, to determine the final frequency offset in a form similar to Equation 11.

$$\begin{matrix}Δ f = \frac{Δθ}{2 π {T}_{c}} & [ Equation 13 ] \\ Δ \hat{f} = \frac{a tan \{ {\sum }_{i = 1}^{N - D} {y}_{i}^{*} {y}_{i + D} \}}{2 π {T}_{c} ( N - D )} & [ Equation 14 ]\end{matrix}$$

Here, T_{c}=0.78125 μs which represents one (1) chip duration, andΔ\hat{f} denotes the estimated frequency offset value.

As discussed, the value of D can be a variable value. If the value of D increases, the resolution increases while the number of estimated samples and diversity gain decreases. Conversely, if the value of D decreases, the resolution decreases while the number of estimated samples and diversity gain increases.

With respect to hardware or structural implementation, the amount of change to the phase difference of D chips can be determined and based on the determined amount, a resolution gain in amount of D can be attained. Further, the frequency offset estimation accuracy and the estimation range can be freely changed by controlling or adjusting the value of D. Here, the maximum value of the estimation range is

$$\frac{\pm 320}{D} kHz .$$

This maximum value can be obtained from Equation 11 and/or can be inferred from

$$- \frac{π}{2} ∼ \frac{π}{2} .$$

Moreover, if the characteristics of D is applied according to the change in D, the frequency offset compensation for more than two (2) levels can be applied according to the AFC scheme. In initial frequency offset estimation stage, which can be interpreted as having a coarse quality, the value of D is reduced to attain an increase in maximum estimation frequency offset range. Furthermore, in an another frequency offset estimation stage, which can be interpreted as having a fine quality, the value of D is increased to attain resolution gain for a more accurate frequency offset estimation.

The frequency offset value obtained via the phase difference between D chips can be used to compensate for the frequency offset through corresponding output value after being processed through a loop filter 34 and a low-pass filter (LPF) 35.

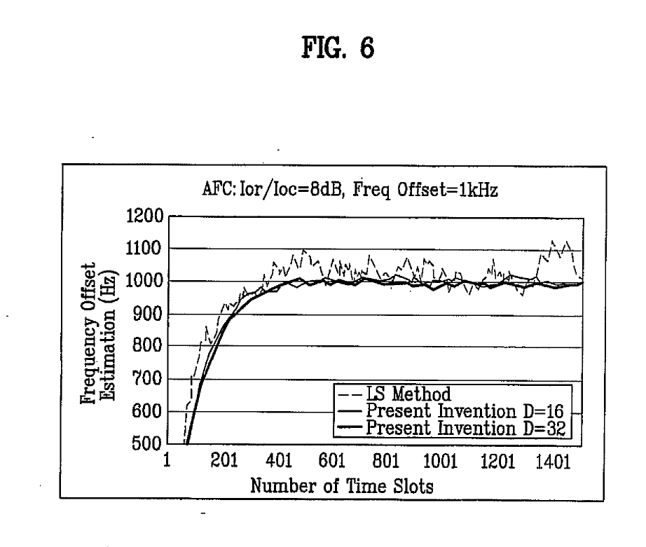

FIG. 6 illustrates a performance graph of the AFC between a least squared (LS) scheme and an embodiment of the present invention. The AFC estimates a frequency offset (e.g., 1 kHz) generated from a reference subcarrier frequency (e.g., 2 GHz) in therange of −0.1 ppm ˜0.1 ppm. In other words, the estimated frequency offset should fall within the range of 1200 Hz ˜800 Hz.

Referring to FIG. 6, Ior/Ioc=8 dB, the initial frequency offset is 1 kHz, and the values of D are 16 and 32. Further, the x-axis refers to a number of used time slots, and y-axis refers to the estimated frequency offset value. The AFC according to the embodiment of the present invention satisfies the features of the AFC discussed above, is also more stable than the conventional AFC, and achieves gain in terms of resolution.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of estimating frequency offset in a code division multiple access (CDMA) wireless communication system, the method comprising:
receiving a training sequence, wherein tile training sequence is represented by a plurality of periodically repeated training symbols;
acquiring each of a plurality of phase difference values using the received training symbols, wherein each phase difference value is obtained by comparing two training symbols which are received in a specified time distance; and
obtaining the frequency offset using the acquired each of the plurality of the phase difference values.

2. The method of claim 1, further comprising combining a plurality of phase difference values acquired using the received training symbols.

3. The method of claim 1, wherein the training sequence includes at least one of a downlink synchronization code and a midamble code.

4. The method of claim 3, wherein the downlink synchronization code is a complex downlink synchronization code including a real value and an imaginary value.

5. The method of claim 3, wherein the midamble code is applied cyclical time-shift method to expand up to 16 types of midamble combinations.

6. The method of claim 3, wherein the same midamble code is used in each cell.

7. The method of claim 1, wherein the training symbols is changed to a complex midamble by applying a quadrature phase shift keying (QPSK) scheme to the training symbols.

8. The method of claim 1, wherein the specified time distance is variable.

9. The method of claim 1, wherein the specified time distance is measured in units of D chips.

10. The method of claim 1, wherein the specified time distance is a multiple of 2.

11. A method of estimating frequency offset in a wireless communication system, the method comprising:
receiving a training sequence, wherein the training sequence is represented by a plurality of periodically repeated training symbols;
acquiring a phase difference value between a first training symbol and a second training symbol, wherein the first training symbol and the second training symbol are received at different time instances; and
determining the frequency offset using the acquired phase difference value.

12. The method of claim 11, wherein if the phase difference value indicates a negative value, the phase is rotated up to π.

13. The method of claim 11, wherein the estimated frequency offset is expressed
$$by Δ \hat{f} = \frac{a tan \{ {\sum }_{i = 1}^{N - D} {y}_{i}^{*} {y}_{i + D} \}}{2 π {T}_{c} ( N - D )} .$$

14. The method of claim 13, wherein Tₑ denotes one chip duration, yᵢ=aᵢe^{jθ}_{₀}, y_{i+D}=a_{i+D}e^{j(θ}_{₀}^{+DΔθ)}, D denotes 2n where n is a positive number between 0<n<N/2, aᵢ denotes a training sequence where i=1, . . . N, yᵢ denotes an input data corresponding to a total of N number of samples for frequency offset estimation, Δθ denotes the phase difference between chips based on frequency offset and θ₀ denotes an initial phase value of the sequence.

15. The method of claim 11, wherein the wireless communication system is a code division multiple access (CDMA) system.

16. The method of claim 11, wherein the wireless communication system is a time division-synchronous code division multiple access (TD-DCDMA) system.

17. The method of claim 11, further comprising combining a plurality of phase difference values acquired using the received training symbols.

18. The method of claim 11, wherein the training sequence includes at least one of a downlink synchronization code and a midamble code.

19. The method of claim 11, wherein the different time instances are indicated in multiple of 2.

20. An apparatus for estimating frequency offset in a code division multiple access (CDMA) wireless communication system, the apparatus comprising:
a phase detection module for receiving a training sequence, and acquiring each of a plurality of phase difference values using the received training sequence, wherein the training sequence is represented by a plurality of periodically repeated training symbols and wherein each phase difference value is obtained by comparing two training symbols which are received in a specified time distance;
a combining module for combining at least one phase difference detected by the phase detection module; and
a frequency offset output module for calculating the frequency offset using the acquired each of the plurality of the phase difference values.
